(19) United States
(12) Patent Application Publication
(10) Pub. No.: US 2007/0106827 A1
(43) Pub. Date: May 10, 2007

(54) Centralized interrupt controller

(76) Inventors: Bryan David Boatright, Austin, TX (US); James Michael Cleary, Austin, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/270,750

(22) Filed: Nov. 8, 2005

(51) Int. Cl. G06F 13/24

(52) U.S. Cl. 710/263

(57) ABSTRACT

A centralized interrupt controller with a single copy of APIC logic provides APIC interrupt delivery services for all processing units of a multi-sequencer chip or system. An interrupt sequencer block of the centralized interrupt controller schedules the interrupt services according to a fairness scheme. At least one embodiment of the centralized interrupt controller also includes firewall logic to filter out transmission of selected interrupt messages. Other embodiments are also described and claimed.

### BACKGROUND

1. Technical Field

The present invention relates to the field of electronic circuitry controlling interrupts. More particularly, this invention relates to a centralized Advanced Programmable Interrupt Controller for a plurality of processing units.

2. Background Art

Fundamental to the performance of any computer system, a processing unit performs a number of operations including control of various intermittent “services” that may be requested by peripheral devices coupled to the computer system. Input/output (“I/O”) peripheral equipment, including such computer items as printers, scanners and display devices require intermittent servicing by a host processor in order to ensure proper functioning. Services, for example, may include data delivery, data capture and/or control signals.

Each peripheral typically has a different servicing schedule that is not only dependent on the type of device but also on its programmed usage. The host processor multiplexes its servicing activity amongst these devices in accordance with their individual needs while running one or more background programs. At least two methods for advising the host of a service need have been used: polling and interrupt methods. In the former method, each peripheral device is periodically checked to see if a flag has been set indicating a service request. In the latter method, the device service request is routed to an interrupt controller that can interrupt the host, forcing a branch from its current program to a special interrupt service routine. The interrupt method is advantageous because the host need not devote unnecessary clock cycles for polling. It is this latter method that the disclosure invention addresses.

With the advent of multi-processor computer systems, interrupt management systems that dynamically distribute the interrupt among the processors have been implemented. An Advanced Programmable Interrupt Controller (“APIC”) is an example of such a multiprocessor interrupt management system. Employed in many multi-processor computer systems, the APIC interrupt delivery mechanism may be used to detect an interrupt request from another processing unit or from a peripheral device and to advise one or more processing units that a particular service corresponding to the interrupt request needs to be performed. Further detail about the APIC interrupt delivery system may be found in U.S. Pat. No. 5,283,904 to Carson et al., entitled “Multiprocessor Programmable Interrupt Controller System.”

Many conventional APICs are hardware intensive in design thereby requiring a large number of gates (i.e., a high gate count). In many multi-processor systems, each core has its own dedicated APIC that is fully self-contained within the core. For other multi-processor systems, each core is a simultaneous multi-threading core with a plurality of logical processors. For such systems, each logical processor is associated with an APIC, such that each multi-threaded core includes a plurality of APIC interrupt delivery mechanisms that each maintain its own architectural state and implements its own control logic, which is generally identical to every other APIC's control logic. For either type of multi-processor system, the die area and leakage power costs for the multiple APICs can be undesirably large. In addition, dynamic power costs related to the operation of multiple APICs in order to deliver interrupts in a multi-processor system can also be undesirably large.

### BRIEF DESCRIPTION OF THE DRAWINGS

Embodiments of the present invention may be understood with reference to the following drawings in which like elements are indicated by like numbers. These drawings are not intended to be limiting but are instead provided to illustrate selected embodiments of an apparatus, system and method for a centralized APIC controller for a plurality of processing units.

FIG. 1 is a block diagram illustrating at least one embodiment of a centralized interrupt controller to provide interrupt control for a plurality of processing units.

FIG. 2 is a block diagram illustrating further detail for at least one embodiment of a centralized interrupt controller.

FIG. 3 is a block diagram illustrating various embodiments of multi-sequencer systems.

FIG. 4 is a block diagram illustrating at least one embodiment of a central repository of interrupt state for a plurality of cores.

FIG. 5 is a state transition diagram illustrating at least one embodiment of the operation of an interrupt sequencer block for a centralized interrupt controller.

FIG. 6 is a block diagram illustrating at least one sample embodiment of a computing system capable of performing disclosed techniques

### DETAILED DESCRIPTION

The following discussion describes selected embodiments of methods, systems and articles of manufacture for a centralized APIC for a plurality of processing units. The mechanisms described herein may be utilized with single-core or multi-core multi-threading systems. In the following description, numerous specific details such as processor types, multi-threading environments, system configurations, and numbers and type of sequencers in a multi-sequencer system have been set forth to provide a more thorough understanding of the present invention. It will be appreciated, however, by one skilled in the art that the invention may be practiced without such specific details. Additionally, some well known structures, circuits, and the like have not been shown in detail to avoid unnecessarily obscuring the present invention.

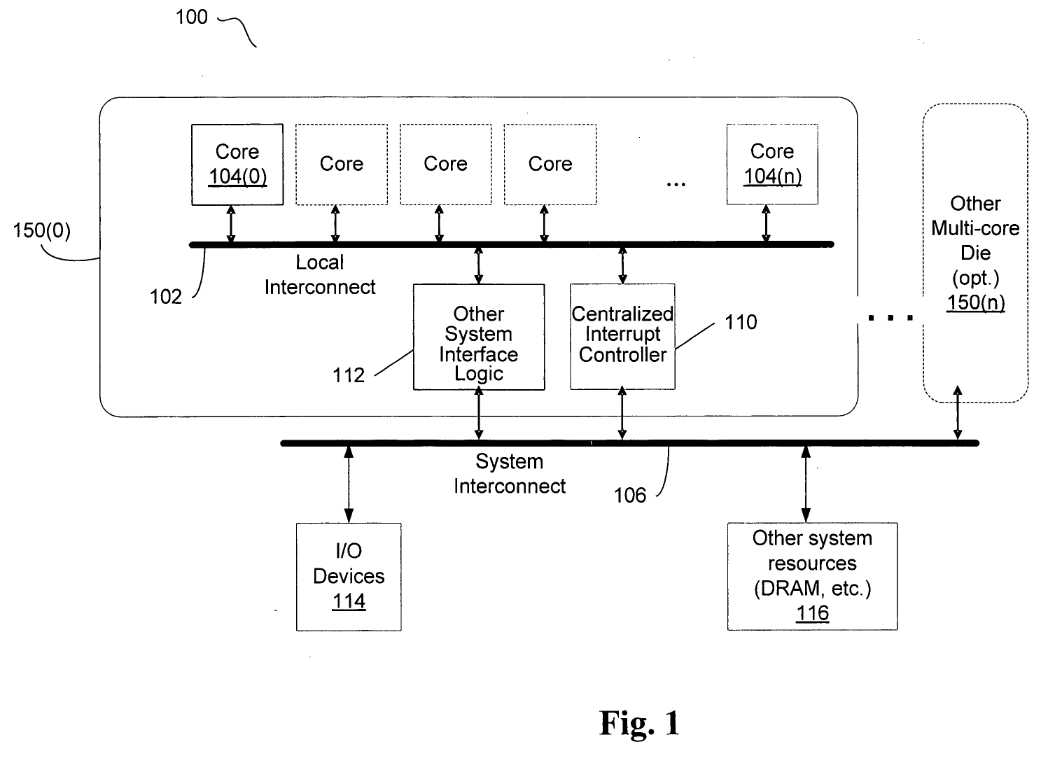

FIG. 1 is a block diagram illustrating at least one embodiment of a system 100 that includes a centralized interrupt controller 110. The system 100 includes a plurality of cores 104(0)-104(n). The dotted lines and ellipses of FIG. 1 illustrate that the system 100 can include any number (n) of cores, where n≧2. One of skill in the art will recognize that an alternative embodiment of the system may include a single simultaneous multi-threading (“SMT”) core (such that n=1), as is explained below.

FIG. 1 illustrates that the single centralized interrupt controller 110 is physically separate from the cores 104(0)-104(n). FIG. 1 also illustrates that each core 104(0)-104(n) of the system 100 is coupled, via a local interconnect 102, to the centralized interrupt controller 110. The centralized interrupt controller 110 thus interfaces with each processing core over the local interconnect 102. The high-level purpose of the centralized interrupt controller 110 is to serially mimic the operation of multiple APICs in a way that appears to the system 100 that those APICs are operating in parallel as they do in traditional per-core APIC systems.

A single core 104 of the system 100 can implement any of various multi-threading schemes, including simultaneous multi-threading (SMT), switch-on-event multi-threading (SoeMT) and/or time multiplexing multi-threading (TMUX). When instructions from more than one hardware thread contexts (“logical processors”) run in the processor 304 concurrently at any particular point in time, it is referred to as SMT. Otherwise, a single-core multi-threading system may implement SoeMT, where the processor pipeline is multiplexed between multiple hardware thread contexts, but at any given time, only instructions from one hardware thread context may execute in the pipeline. For SoeMT, if the thread switch event is time based, then it is TMUX. Although single cores that support SoeMT and TMUX schemes can support multi-threading, they are referred to herein as “single-threaded” cores because only instructions from one hardware thread context may be executed at any given time.

Each core 104 may be a single processing unit capable of executing a single thread. Or, one or more of the cores 104 may be a multi-threading core that performs SoeMT or TMUX multi-threading, such that the core only executes instructions for one thread at a time. For such embodiments, the core 104 is referred to as a “processing unit.”

For at least one alternative embodiment, each of the cores 104 is a multi-threaded core, such as an SMT core. For an SMT core 104, each logical processor of the core 104 is referred to as a “processing unit.” As used herein, a “processing unit” may be any physical or logical unit capable of executing a thread. Each processing unit may include next instruction pointer logic to determine the next instruction to be executed for the given thread. As such, a processing unit may be interchangeably referred to herein as a “sequencer.”

For either embodiment (single-threaded cores vs. multi-threaded cores), each processing unit is associated with its own interrupt controller functionality, although logic for such functionality is not self-contained within each processing unit, but is instead provided by the centralized interrupt controller 110. If any of the cores 104 are SMT cores, each logical processor of each core 104 may be coupled to the centralized interrupt controller 110 via the local interconnect 102.

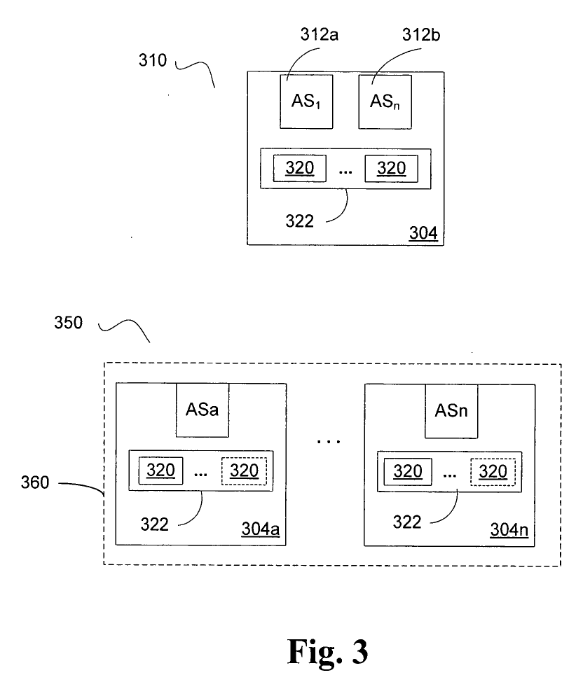

Turning briefly to FIG. 3, as is explained above, a processing unit (or “sequencer”) may be a logical processor or a physical core. Such distinction between logical and physical processing units is illustrated in FIG. 3. FIG. 3 is a block diagram illustrating selected hardware features of embodiments 310, 350 of a multi-sequencer system capable of performing disclosed techniques.

FIG. 3 illustrates selected hardware features of a single-core multi-sequencer multi-threading environment 310. FIG. 3 also illustrates selected hardware features of a multiple-core multi-threading environment 350, where each sequencer is a separate physical processor core.

In the single-core multi-threading environment 310, a single physical processor 304 is made to appear as multiple logical processors (not shown), referred to herein as LP₁ through LPₙ, to operating systems and user programs. Each logical processor LP₁ through LPₙ maintains a complete set of the architecture state AS₁-ASₙ, respectively. The architecture state includes, for at least one embodiment, data registers, segment registers, control registers, debug registers, and most of the model specific registers. The logical processors LP₁-LPₙ share most other resources of the physical processor 304, such as caches, execution units, branch predictors, control logic and buses. However, each logical processor LP₁-LPₙ may be associated with its own APIC.

Although many hardware features may be shared, each thread context in the multi-threading environment 310 can independently generate the next instruction address (and perform, for instance, a fetch from an instruction cache, an execution instruction cache, or trace cache). Thus, the processor 304 includes logically independent next-instruction-pointer and fetch logic 320 to fetch instructions for each thread context, even though the multiple logical sequencers may be implemented in a single physical fetch/decode unit 322. For a single-core multi-threading embodiment, the term “sequencer” encompasses at least the next-instruction-pointer and fetch logic 320 for a thread context, along with at least some of the associated architecture state, 312, for that thread context. It should be noted that the sequencers of a single-core multi-threading system 310 need not be symmetric. For example, two single-core multi-threading sequencers for the same physical core may differ in the amount of architectural state information that they each maintain.

Thus, for at least one embodiment, the multi-sequencer system 310 is a single-core processor 304 that supports concurrent multi-threading. For such embodiment, each sequencer is a logical processor having its own instruction next-instruction-pointer and fetch logic and its own architectural state information, although the same physical processor core 304 executes all thread instructions. For such embodiment, the logical processor maintains its own version of the architecture state, although execution resources of the single processor core may be shared among concurrently-executing threads.

FIG. 3 also illustrates at least one embodiment of a multi-core multi-threading environment 350. Such an environment 350 includes two or more separate physical processors 304a-304n that is each capable of executing a different thread/shred such that execution of at least portions of the different threads/shreds may be ongoing at the same time. Each processor 304a through 304n includes a physically independent fetch unit 322 to fetch instruction information for its respective thread or shred. In an embodiment where each processor 304a-304n executes a single thread/shred, the fetch/decode unit 322 implements a single next-instruction-pointer and fetch logic 320. However, in an embodiment where each processor 304a-304n supports multiple thread contexts, the fetch/decode unit 322 implements distinct next-instruction-pointer and fetch logic 320 for each supported thread context. The optional nature of additional next-instruction-pointer and fetch logic 320 in a multiprocessor environment 350 is denoted by dotted lines in FIG. 3.

For at least one embodiment of the multi-core system 350 illustrated in FIG. 3, each of the sequencers may be a processor core 304, with the multiple cores 304a-304n residing in a single chip package 360. Each core 304a-304n may be either a single-threaded or multi-threaded processor core. The chip package 360 is denoted with a broken line in FIG. 3 to indicate that the illustrated single-chip embodiment of a multi-core system 350 is illustrative only. For other embodiments, processor cores of a multi-core system may reside on separate chips. That is, the multi-core system may be a multi-socket symmetric multiprocessing system.

For ease of discussion, the following discussion focuses on embodiments of the multi-core system 350. However, this focus should not be taken to be limiting, in that the mechanisms described below may be performed in either a multi-core or single-core multi-sequencer environment.

Returning to FIG. 1, one can see that the cores 104(0)-104(n) of the system 100 may be coupled to each other via the local interconnect 102. The local interconnect 102 may provide all communication functions required among the cores (such as, for example, cache snoops and the like). Each of the cores 104(0)-104(n) may include a relatively small interface block to send and receive interrupt-related messages over the local interconnect 102. Generally, such interface of the cores is relatively simplistic in that it does not retain architectural state related to the interrupt-related messages, nor does it prioritize interrupts or perform other APIC-related functions that are, instead, performed by the centralized interrupt controller 110 as described herein.

The cores 104(0)-104(n) may reside on a single die 150(0). For at least one embodiment, the system 100 illustrated in FIG. 1 may further include optional additional die. The optional nature of additional one or more dies (up through 150(n)) is illustrated in FIG. 1 with dotted lines and ellipses. FIG. 1 illustrates that an interrupt message from a processing unit on another die (150(n)) may be communicated over a system interconnect 106 to a first die (150(0)). The centralized interrupt controller 106 is coupled via the system interconnect 106 to any other dies (up through 150(n)) and to peripheral I/O devices 114.

One of skill in the art will recognize that the die 150 configuration shown in FIG. 1 is for illustrative purposes only and should not be taken to be limiting. For alternative embodiments, for example, the elements for both 150(0) and 150(n) may reside on the same piece of silicon and be coupled to the same local interconnect 102. Conversely, each core 104 need not necessarily reside on the same chip. Each core 104(0)-104(n) and/or the local interconnect 102 may not reside on the same die 150.

Each of the cores 104(0)-104(n) of the system 100 may further be coupled via the local interconnect 102 to other system interface logic 112. Such logic 112 may include, for example, cache coherence logic or other interface logic that allows the sequencers to interface with other system elements via the system interconnect. The other system interface logic 112 may, in turn, be coupled to other system elements 116 (such as, for example, a memory) via the system interconnect 106.

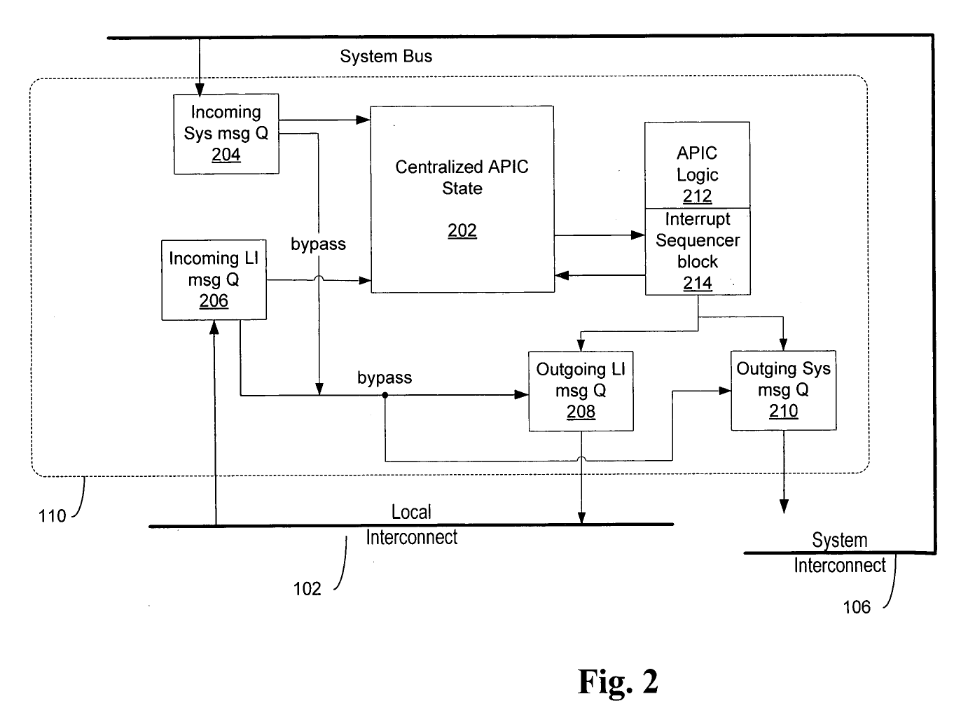

FIG. 2 is a block diagram illustrating further detail for at least one embodiment of a centralized interrupt controller 110. Generally, FIG. 2 illustrates that, although the centralized interrupt controller 110 is physically separate from the cores of the system (see, e.g., cores 104(0)-104(n) of FIG. 1), the centralized interrupt controller 110 nonetheless maintains the complete architectural state of each APIC instance, one of which is associated with each of the sequencers. The centralized interrupt controller 110 manages all of the interrupt queuing and prioritization functions that would ordinarily be handled by per-core dedicated APICs in traditional systems. As is explained in further detail below, the centralized interrupt controller 110 may also act as a firewall between the sequencers and the rest of the system that is coupled to the system interconnect 106.

FIG. 2 illustrates that the centralized interrupt controller 110 includes a centralized APIC state 202. The APIC state 202 includes architectural state ordinarily associated with typical APIC processing. That is, APIC processing is an architecturally visible feature to application programmers, and it is not intended that such interface be changed by the present disclosure. Whether a system includes the traditional APIC hardware (that is, one self-contained APIC for each processing unit) or a centralized interrupt controller as discussed herein, it is anticipated that such hardware design choice should be, for at least one embodiment, transparent to the application programmer. In this manner, the area, dynamic power, and power leakage costs can be reduced by utilizing a single centralized interrupt controller 110 for a system, while at the same time maintaining the same architectural interface that operating system vendors and application programmers expect.

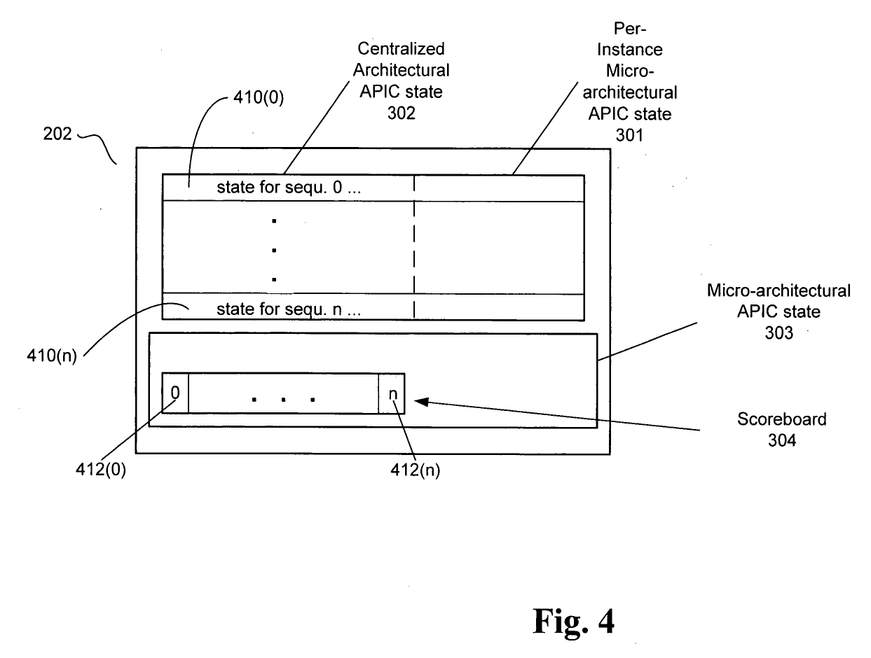

Thus, the architectural state maintained as a central repository of APIC state information at block 202 is generally that state which is maintained for each APIC in a traditional system. For example, if there are eight sequencers in a system, the centralized APIC state 202 may include an array of eight entries, with each entry reflecting the architectural APIC state that is maintained for a sequencer in traditional systems. (The discussion of FIG. 4, below, indicates that each entry may also include certain microarchitectural state as well.)

For at least one embodiment, the centralized APIC state 202 is implemented as a single memory storage area, such as a register file or array. A register file organization may allow better area efficiency than prior approaches that implemented per-core APIC state as random logic.

Generally, the centralized interrupt controller 110 monitors the reception of interrupt messages received over the local interconnect 102 and/or the system interconnect 106, and stores pertinent messages in the appropriate entry of the register file 202. For at least one embodiment, this is accomplished by monitoring the destination address for incoming messages, and storing the messages in the APIC instance entry associated with the destination address. Such functionality may be performed by the incoming message queues 204, 206, as is explained in further detail below.

Similarly, the centralized interrupt controller 110 may monitor the generation of outgoing interrupt messages and may store the messages in the appropriate entry of the register file 202 until such messages are serviced and delivered. For at least one embodiment, this is accomplished by monitoring the source address for the outgoing messages, and storing the messages in the APIC instance entry associated with the source address. Such functionality may be performed by the outgoing message queues 208, 210, as is explained in further detail below.

Generally, the interrupt sequencer block 214 of the centralized interrupt controller 110 may then schedule such pending interrupt messages, as reflected in the centralized APIC state 202, for service. As is explained in further detail below, this may be accomplished according a fairness scheme such that no sequencer's pending interrupt activity is repeatedly ignored. The interrupt sequencer block 214 may invoke APIC interrupt delivery logic 212 to perform the servicing.

FIG. 2 thus illustrates that the centralized interrupt controller 110 includes APIC interrupt delivery logic 212. Rather than replicating the APIC logic for each sequencer (e.g., each single-threaded core or each logical processor of an SMT core) of a system, the centralized interrupt controller 110 provides a single, non-redundant copy of the APIC logic 212 to service interrupts for all sequencers of the system.

For example, if a system (such as, e.g., system 100 of FIG. 1) includes four cores that each supports eight concurrent SMT threads, then the system traditionally would require thirty-two copies of the APIC logic 212. Instead, the centralized interrupt controller 110 illustrated in FIG. 2 utilizes a single copy of the APIC logic 212 to provide interrupt controller services to all of the thirty-two threads that are active at a given time.

Because multiple sequencers of a system may have pending interrupt activity at the same time, the APIC logic 212 may be the subject of contention from multiple sequencers. The centralized interrupt controller 110 therefore includes an interrupt sequencer block 214. The interrupt sequencer block 214 “sequences” servicing of all interrupts in the system in a manner that provides fair access for each of the sequencers to the APIC logic 212. In essence, the interrupt sequencer block 214 of the centralized interrupt controller 110 controls access to single APIC logic block 212.

Accordingly, the interrupt sequencer block 214 controls access of the sequencers to the shared APIC logic 212. This functionality contrasts with traditional APIC systems that provide a dedicated APIC logic block for each sequencer, such that each sequencer has immediate ad hoc access to the APIC logic. The single APIC logic block 212 may provide the full architectural requirements of an APIC in terms of interrupt prioritization, etc., for each of the processing units of a system.

For any particular processing unit of a system, the source/destination of interrupts that pass through the APIC can be either other processing units or peripheral devices. Intra-die processing unit interrupts are delivered by the centralized interrupt controller 110 over the local interconnect 102. Interrupts to/from peripheral devices or processing units on other die are delivered over the system interconnect 106.

FIG. 2 illustrates that the centralized interrupt controller 10 includes four message queues in order to handle the incoming and outgoing interrupt messages over the local interconnect 102 and system interconnect 106: an incoming system message queue 204, an incoming local message queue 206, an outgoing local message queue 208, and an outgoing system message queue 210. The incoming local message queue 206 and the outgoing local message queue 208 are coupled to the local interconnect 102; while the incoming system message queue 204 and the outgoing system message queue 210 are coupled to the system interconnect 106. Each of the queues 204, 206, 208, 210 is a mini-controller queue that includes data storage as well as control logic.

Further discussion of the operation of the queues 204, 206, 208, 210 is made with reference to FIGS. 1, 2 and 4. FIG. 4 provides a more detailed view of at least one embodiment of the centralized APIC state 202. FIG. 4 illustrates that the centralized APIC state 202 may include both the architectural state 302 as well as microarchitectural state 301, 303. As is stated above, the architectural state 302 maintained for each of the sequencers 104(0)-104(n) reflects the APIC state traditionally associated with a sequencer. Each entry 410 of the architectural APIC state 302 is referred to herein as an “APIC instance.” For example, incoming interrupt messages for an APIC instance may be stored in the entry 410 of the architectural APIC state 302 associated with that instance. For at least one embodiment, up to 240 incoming interrupt messages may be maintained in the entry 410 for an APIC instance.

In addition to the architectural state 302, the centralized APIC state 202 may include microarchitectural state 301 associated with each APIC instance 410 as well as a general microarchitectural state 303. The general microarchitectural state 303 may include a scoreboard 304 to help the interrupt sequencer block 214 (see FIG. 2) to determine which sequencers need access to the APIC logic 212 (see FIG. 2). For at least one embodiment, the scoreboard 304 may maintain a bit for each sequencer in the system. The value in a sequencer's bit may indicate whether the sequencer has any pending activity for which the APIC logic 212 is required. For at least one embodiment, the scoreboard 304 may be read atomically, so that the interrupt sequencer block 214 (FIG. 2) can easily and quickly ascertain which sequencers need attention of the APIC logic 212.

While one feature of the interrupt sequencer block 214 is to fairly allow access to the APIC logic 212, the scoreboard 304 allows the fairness scheme to be employed without requiring that the interrupt sequencer block 214 waste processing resources on sequencers that do not currently need APIC logic 212 processing. The scoreboard thus tracks which APIC instances have work to do based on incoming messages and the current state of processing for those outstanding requests. The interrupt sequencer block 214 reads the current state from the centralized APIC state 202 for an active APIC instance, takes actions appropriate for the current state (as recorded in both the architectural state 302 and microarchitectural state 301 for that particular APIC instance 410) and then repeats the process for the next APIC instance with pending work (as indicated by the bits in the scoreboard 304).

When an incoming interrupt message comes over local interconnect 102 to target another sequencer on the same die, the incoming local message queue 206 receives the message and determines its destination. An interrupt message could target one, many, none or all of the sequencers. The queue 206 may write into the architectural state entry (see, e.g., 410 of FIG. 4) for each targeted sequencer in order to queue up the interrupt(s). In such case, the queue 206 also sets the scoreboard entry for the targeted sequencer(s), if such scoreboard entry is not already set, in order to indicate that interrupt activity is pending and that the services of the single APIC logic block 212 is needed for the target sequencer(s).

FIG. 4 illustrates, however, that some interrupts may be bypassed directly from the incoming local message queue 206 to an outgoing queue 208, 210, without being queued up in the centralized APIC state 202. This may occur, for example, for a broadcast message that is not specifically addressed to a particular processor. FIG. 4 illustrates that similar bypass processing may occur from the incoming system message queue 204 (discussed below) as well.

Processing similar to that discussed above for queue 206 may also occur when an incoming interrupt message comes over the system interconnect 106 (from an I/O device or a sequencer on another die) to target one of the sequencers 104(0)-104(n). The incoming system message queue 204 receives the message and determines its destination. The queue 206 writes into the architectural state entry 410 for each targeted sequencer in order to queue up the interrupt(s) and updates the scoreboard entry 412 for any targeted sequencer(s) accordingly. Of course, the incoming message may, alternatively, be bypassed as discussed above.

One or more of the message queues 204,206, 208, 210 may implement a firewall feature for outgoing and/or incoming messages. Regarding this firewall feature, FIG. 2 is discussed in connection with FIG. 1.

Regarding incoming messages, the incoming system message queue 204 may act as an interrupt firewall to prevent unnecessary processing for messages that do not target a sequencer on the die 150 associated with the centralized interrupt controller 110. As is illustrated in FIG. 1, a system 100 may include a plurality of multi-sequencer dies 150(0)-150(n). An interrupt generated by a sequencer of a particular die may be transmitted to the other dies via the system interconnect 106. Similarly, an interrupt generated by a peripheral device 114 may be transmitted to the dies over the system interconnect 106.

The centralized interrupt controller 110 (and, in particular, the incoming system message queue 204) for a die 150 may determine whether the destination address for such messages includes any sequencer (e.g., a core or logical processor) on it die 150. If the message does not target any core or logical processor on the local interconnect 102 associated with that die, the incoming system message queue 204 declines to forward the message to any of the sequencers on the local interconnect 102. In this manner, the incoming system message queue avoids “waking” those cores/threads for them simply to determine that no action is necessary. This saves power and conserves the bandwidth of the local interconnect 102 because it eliminates the need for multiple individual sequencers to “wake up” from a power-saving state only to determine that the message was not targeted for them.

Even if one or more of the logical processors are not in a power-saving state, the incoming system message queue 204 may still perform the firewall feature so as not to interrupt logical processors from the work that they are currently doing, simply to determine that the incoming interrupt message requires no action on their part.

For at least one embodiment, a firewall may also be implemented for outgoing messages. This may be true for outgoing system messages as well as, for at least some embodiments, outgoing local messages as well. For at least one embodiment, the firewall feature for local messages is only implemented for a system whose local interconnect 102 supports a feature that allows targeted interrupt messages to be delivered to a particular sequencer, rather than requiring that each message on the local interconnect 102 be broadcast to all sequencers. In such cases, the outgoing local message queue 208 may send each interrupt message on the local interconnect 102 as a unicast or multicast message to only the sequencer(s) to be targeted by the message. In such manner, non-targeted sequencers need not interrupt their processing to determine that their action is not required for the particular interrupt message. Outgoing system messages may be similarly targeted, so that they are not unnecessarily sent to non-targeted entities.

FIG. 2 therefore illustrates that, after the incoming interrupt messages have been placed into the centralized APIC state 202 by the incoming message queues 204, 206, then the interrupt sequencer block 214 may provide for fair access among the sequencers of a system to the single copy of the APIC logic 212 (see FIG. 2) in order to perform APIC processing for the system. The interrupt sequencer block 214 may implement this fairness scheme by, in essence, traversing through the APIC state 202 sequentially and providing access to the APIC logic 212 for the next sequencer that needs it. The fairness scheme implemented by the interrupt sequencer block 214 may thus permit each sequencer to have equal access to the interrupt delivery block.

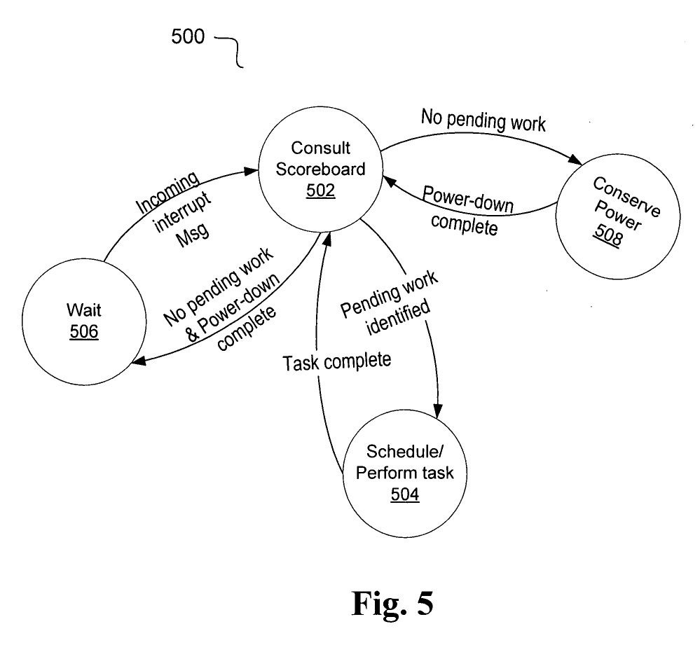

For at least one embodiment, this conceptual sequential stepping through the entries of the APIC state 202 is made more efficient by the use of a scoreboard (see 304, FIG. 4), which may be queried atomically in order to determine which active sequencer is the “next” to need APIC service. For at least one embodiment the sequential access may be controlled according to the method that is described in further detail below in connection with FIG. 5.

FIG. 5 is a state diagram that illustrates a method 500 employed by at least one embodiment of the interrupt sequencer block 214 (see FIG. 2) to provide for fair access among the sequencers of a system to the single copy of the APIC logic 212 (see FIG. 2) in order to perform APIC processing for the system. The following discussion of FIG. 5 makes reference to FIGS. 2 and 4.

Generally, FIG. 5 illustrates that the interrupt sequencer block 214 reads the current state from the centralized APIC state 202 for an active APIC instance, and takes actions appropriate for the current state, and then repeats the process for the next APIC instance with pending work.

FIG. 5 illustrates that the method 500 may begin at state 502. At state 502 the interrupt sequencer block 214 consults the scoreboard 304 in order to determine which APIC instance(s) have work to do. As is stated above, there may be one entry 412 in the scoreboard 304 for each APIC instance. The entry 412 may be, for at least one embodiment, a one-bit entry. The bit 412 may be set when an incoming message is written to the centralized APIC state 202 for that particular APIC instance.

Of course, one of skill in the art will recognize that the scoreboard 304 is a performance enhancement that need not necessarily be present in all embodiments. For at least one alternative embodiment, for example, the interrupt sequencer block 214 may traverse through each entry of the centralized APIC state 202 in an orderly fashion (sequential, etc.) in order to determine if any active APIC instances need service.

If no bit in the scoreboard 304 is set, then none of the sequencers have pending APIC events. In such case, the method 500 may transition from state 502 to state 508. At state 508, the method 500 may power down at least a portion of the APIC logic block 212, in to conserve power while the logic 212 is not needed. When the power-down is complete, the method 500 transitions back to state 502 to determine if any new APIC activity is detected.

At state 502, if no new activity is detected (i.e., no entry in the scoreboard 304 is set), and the APIC logic 212 has already been powered down, then the method 500 may transition from state 502 to state 506 to await new APIC activity.

During the wait state 506, the method 500 may periodically assess the contents of the scoreboard 304 to determine if any APIC instance has acquired pending APIC work. Any incoming APIC message as reflected in the scoreboard contents 304 causes a transition from state 506 to state 502. The discussion, above, of the incoming local message queue 204 and the incoming system message queue 206 provide a description of how the architectural APIC state 302 and, for at least some embodiments, the scoreboard 304 entries are updated to reflect that an APIC instance has acquired pending APIC work.

The method 500 may determine at state 502 that at least one APIC instance has pending APIC work to do if any entry 412 in the scoreboard 304 is set. If more than one such entry is set, the interrupt sequencer block 214 determines which APIC instance is to next receive servicing by the APIC logic 212. For at least one embodiment, the interrupt sequencer block 214 performs this determination by selecting the next scoreboard entry that is set. In such manner, the interrupt sequencer block 214 imposes a fairness scheme by sequentially selecting the next active APIC instance for access to the APIC logic 212.

Upon selection of an APIC instance at state 502, the method 500 transitions from block 502 to block 504. At block 504, the interrupt sequencer block 214 reads the entry 410 for the selected virtual APIC from the centralized APIC state 302. In this manner, the interrupt sequencer block 214 determines which APIC events are pending for the selected APIC instance. Multiple APIC events may be pending, and therefore reflected in the APIC entry 410. Only one pending event is processed for an APIC instance during each iteration of state 504. Accordingly, the round-robin type of sequential fairness scheme may be maintained.

To select among multiple pending interrupt events for the same active APIC instance, the interrupt sequencer block 214 performs prioritization processing during state 504. Such prioritization processing may emulate the prioritization scheme performed by dedicated APICs in traditional systems. For example, APIC interrupts are defined to fall into classes of importance. The architectural state entry 410 (FIG. 4) for each APIC instance may, for at least one embodiment, hold up to 240 pending interrupts per logical processor. These can fall into 16 classes of importance, and they are classified in prioritized groups of 16. Interrupts of class 16-31 are of a higher priority than those in class 32-47, etc. The lower the interrupt class number, the higher the interrupt priority. Accordingly, the interrupt sequencer block 214 looks at the 240 bits for an APIC instance and, if more than one is set, it picks just one event (based on existing architectural prioritization rules for APIC) at state 504. For at least one embodiment, the interrupt sequencer block 214 invokes the APIC logic 212 to perform this prioritization.

The method 500 then schedules or performs the appropriate action for the selected event during state 504. For example, the event may be that an acknowledgement is being awaited for an interrupt message that was previously sent out from one of the outgoing message queues. Alternatively, the event may be that an outgoing interrupt message needs to be sent. Or, an incoming interrupt message or acknowledgement may need to be serviced for one of the sequencers. The interrupt sequencer block 214 may activate the APIC logic 212 to service the event at state 504.

In the case that an acknowledgement is being awaited, the interrupt sequencer block 214 may consult the microarchitectural state 303 to determine that such acknowledgement is being awaited. If so, the interrupt sequencer block 214 consults the appropriate entry of the APIC state 202 to determine at state 504 whether the acknowledgement has been received. If not, the state 504 is exited so that an event for the next sequencer may be processed.

If the acknowledgement has been received, the microarchitectural state 303 is updated to reflect that the acknowledgement is no longer being awaited. The interrupt sequencer block 214 may also clear the scoreboard 304 entry for the APIC instance before transitioning back to state 502. For at least one embodiment, the scoreboard entry 304 is cleared only if the currently-serviced event was the only event pending for the APIC instance.

If, as another example, the event to be serviced at state 504 is the sending of an interrupt message (over the local interconnect 102 or the system interconnect 106), such event may be serviced at state 504 as follows. The interrupt sequencer block 214 determines from the APIC instance for the currently-serviced logical processor which outgoing message needs to be delivered, given the priority processing described above. The outgoing message is then scheduled for delivery, with the desired destination address, to the appropriate outgoing message queue (outgoing local message queue 208 or outgoing system message queue 210).

If the outgoing message requires additional service before the event has been fully serviced, such as receipt of an acknowledgement, the centralized controller 110 may update microarchitectural state 303 to indicate that further service is required for this event. (Incoming acknowledgements over the local interconnect 102 or system interconnect 106 may be queued up in the incoming message queues 204, 206 and eventually updated to the centralized APIC state 202 so that they can be processed during the next iteration of state 504 for the relevant APIC instance.) The method then transitions from state 504 to state 502.

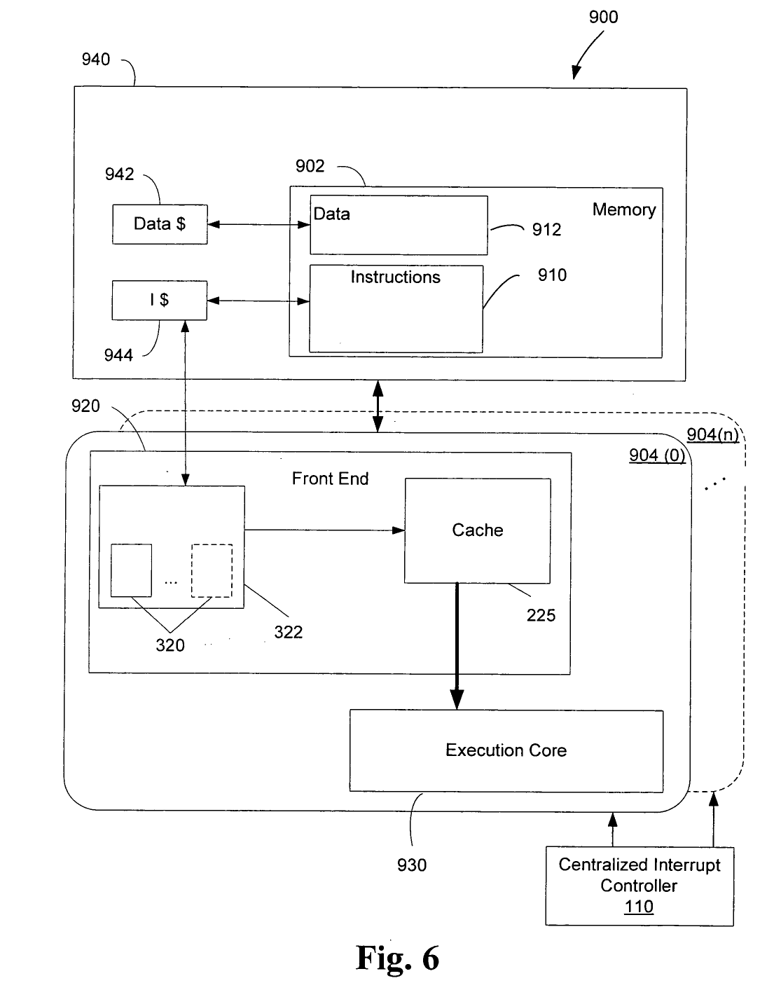

FIG. 6 illustrates at least one sample embodiment of a multi-threaded computing system 900 capable of performing disclosed techniques. The computing system 900 includes at least one processor core 904(0) and a memory system 940. The system 900 may include additional cores (up to 904(n)), as indicated by dotted lines and ellipses.

Memory system 940 may include larger, relatively slower memory storage 902, as well as one or more smaller, relatively fast caches, such as an instruction cache 944 and/or a data cache 942. The memory storage 902 may store instructions 910 and data 912 for controlling the operation of the processor 904.

Memory system 940 is intended as a generalized representation of memory and may include a variety of forms of memory, such as a hard drive, CD-ROM, random access memory (RAM), dynamic random access memory (DRAM), static random access memory (SRAM), flash memory and related circuitry. Memory system 940 may store instructions 910 and/or data 912 represented by data signals that may be executed by processor 904. The instructions 910 and/or data 912 may include code and/or data for performing any or all of the techniques discussed herein.

FIG. 6 illustrates that each processor 904 may be coupled to the centralized interrupt controller 110. Each processor 904 may include a front end 920 that supplies instruction information to an execution core 930. Fetched instruction information may be buffered in a cache 225 to await execution by the execution core 930. The front end 920 may supply the instruction information to the execution core 930 in program order. For at least one embodiment, the front end 920 includes a fetch/decode unit 322 that determines the next instruction to be executed. For at least one embodiment of the system 900, the fetch/decode unit 322 may include a single next-instruction-pointer and fetch logic 320. However, in an embodiment where each processor 904 supports multiple thread contexts, the fetch/decode unit 322 implements distinct next-instruction-pointer and fetch logic 320 for each supported thread context. The optional nature of additional next-instruction-pointer and fetch logic 320 in a multiprocessor environment is denoted by dotted lines in FIG. 6.

Embodiments of the methods described herein may be implemented in hardware, hardware emulation software or other software, firmware, or a combination of such implementation approaches. Embodiments of the invention may be implemented for a programmable system comprising at least one processor, a data storage system (including volatile and non-volatile memory and/or storage elements), at least one input device, and at least one output device. For purposes of this application, a processing system includes any system that has a processor, such as, for example; a digital signal processor (DSP), a microcontroller, an application specific integrated circuit (ASIC), or a microprocessor.

A program may be stored on a storage media or device (e.g., hard disk drive, floppy disk drive, read only memory (ROM), CD-ROM device, flash memory device, digital versatile disk (DVD), or other storage device) readable by a general or special purpose programmable processing system. The instructions, accessible to a processor in a processing system, provide for configuring and operating the processing system when the storage media or device is read by the processing system to perform the procedures described herein. Embodiments of the invention may also be considered to be implemented as a machine-readable storage medium, configured for use with a processing system, where the storage medium so configured causes the processing system to operate in a specific and predefined manner to perform the functions described herein.

Sample system 900 is representative of processing systems based on the Pentium®, Pentium® Pro, Pentium® II, Pentium® III, Pentium® 4, Itanium®, and Itanium® 2 microprocessors and the Mobile Intel® Pentium® III Processor—M and Mobile Intel® Pentium® 4 Processor—M available from Intel Corporation, although other systems (including personal computers (PCs) having other microprocessors, engineering workstations, personal digital assistants and other hand-held devices, set-top boxes and the like) may also be used. For one embodiment, sample system may execute a version of the Windows™ operating system available from Microsoft Corporation, although other operating systems and graphical user interfaces, for example, may also be used.

While particular embodiments of the present invention have been shown and described, it will be obvious to those skilled in the art that changes and modifications can be made without departing from the scope of the appended claims. For example, at least one embodiment of the centralized APIC state 202 may include only a single read port and a single write port. For such embodiment, the incoming system message queue 204, incoming local message queue 206, and the interrupt sequencer block 214 may utilize arbitration logic (not shown) in order to gain access to the centralized APIC state 202.

Also, for example, at least one embodiment of the method 500 illustrated in FIG. 5 may exclude state 508. One of skill in the art will recognize that state 508 merely provides a performance enhancement (power savings) but is not required for embodiments of the invention embodiment in the appended claims.

Also, for example, it is stated above that at least one embodiment of the centralized interrupt controller 110 discussed above may exclude the scoreboard 304. For such embodiment, the interrupt sequencer 214 may sequentially traverse through the entries 410 of the architectural APIC state 302 in order to determine the next APIC instance to receive service from the APIC logic 212.

Accordingly, one of skill in the art will recognize that changes and modifications can be made without departing from the present invention in its broader aspects. The appended claims are to encompass within their scope all such changes and modifications that fall within the true scope of the present invention.

What is claimed is:

1. An apparatus comprising:
a single logic block to perform prioritization and control functions for the delivery of interrupt messages to and from a plurality of processing units, wherein the logic block is shared among the plurality of processing units;
an interrupt sequencer block, coupled to the logic block, to schedule interrupt events for the plurality of processing units for processing by the logic block;
a storage area to maintain architectural interrupt state information for each of the plurality of processing units;
one or more input message queues to receive incoming interrupt messages and to place information from the messages into the storage area; and
one or more output message queues to send outgoing interrupt messages.

2. The apparatus of claim 1, wherein:
the single logic block includes non-redundant circuitry rather than including redundant logic for each processing unit.

3. The apparatus of claim 1, wherein:
the interrupt sequencer block is to schedule the interrupt events for the plurality of processing units according to a fairness scheme.

4. The apparatus of claim 3, wherein:
the interrupt sequencer block is to schedule the interrupt events for the plurality of processing units according to a sequential traversal of the storage area.

5. The apparatus of claim 1, further comprising:
a scoreboard to maintain data regarding which of the processing units has a pending interrupt event.

6. The apparatus of claim 1, wherein:
the storage area is further to store microarchitectural state information.

7. The apparatus of claim 1, wherein:
said plurality of processors are to communicate over a local interconnect.

8. The apparatus of claim 7, wherein:
the one or more input message queues includes a message queue to receive incoming interrupt messages over the local interconnect; and
the one or more output message queues includes a message queue to send outgoing interrupt messages over the local interconnect.

9. The apparatus of claim 7, wherein:
the one or more input message queues includes a message queue to receive incoming interrupt messages over a system interconnect; and
the one or more output message queues includes a message queue to send outgoing interrupt messages over the system interconnect.

10. The apparatus of claim 1, wherein said one or more outgoing message queues are further to:
retrieve information about said outgoing interrupt messages from the storage area.

11. The apparatus of claim 1, wherein said one or more outgoing message queues further comprise:
firewall logic to inhibit the transmission of one or more of the outgoing interrupt messages.

12. The apparatus of claim 1, wherein said one or more incoming message queues further comprises
firewall logic to inhibit the transmission of one or more of the incoming interrupt messages to one or more of the processing units.

13. A method comprising:
consulting a storage array to determine architectural interrupt state for one of a plurality of processing units; and
scheduling one of the processing units for interrupt delivery services of a non-redundant interrupt delivery block;
wherein said scheduling is performed according to a fairness scheme that permits each processing unit to have equal access to the interrupt delivery block.

14. The method of claim 13, wherein:
said interrupt delivery block includes advanced programmable interrupt controller logic.

15. The method of claim 13, wherein: said fairness scheme is a sequential round-robin scheme for those processing units that have one or more pending interrupt events.

16. A system, comprising:
a plurality of processing units to execute one or more threads;
a memory coupled to the processing units; and
a shared interrupt controller to provide interrupt delivery services for the plurality of processing units.

17. The system of claim 16, wherein:
the shared interrupt controller is further to provide APIC interrupt delivery services for the plurality of processing units.

18. The system of claim 16, further comprising:
the processing units do not include self-contained APIC interrupt delivery logic.

19. The system of claim 16, wherein:
said shared interrupt controller further includes firewall logic.

20. The system of claim 16, further comprising:
a local interconnect coupled among the plurality of processing units.

21. The system of claim 20, wherein said shared interrupt controller further comprises:
firewall logic to inhibit the transmission of one or more interrupt messages over the local interconnect.

22. The system of claim 16, further comprising:
a system interconnect coupled to the shared interrupt controller.

23. The system of claim 22, wherein said shared interrupt controller further comprises:
firewall logic to inhibit the transmission of one or more interrupt messages over the system interconnect.

24. The system of claim 16, wherein:
said shared interrupt controller is further to schedule serial servicing of interrupts among the plurality of processing units.
